(19) United States
(12) Patent Application Publication
(10) Pub. No.: US 2006/0063872 A1
(43) Pub. Date: Mar. 23, 2006

(54) Direct to substrate coatings

(76) Inventors: Laurence R. Teachout, Aliso Viejo, CA (US); Eric M. Morris, Irvine, CA (US); Richard A. Albers, Irvine, CA (US)

Correspondence Address: SHELDON & MAK, INC, 225 SOUTH LAKE AVENUE, 9TH FLOOR, PASADENA, CA, 91101, US

(21) Appl. No.: 11/036,416

(22) Filed: Jan. 14, 2005

Related U.S. Application Data
(60) Provisional application No. 60/536,950, filed on Jan. 16, 2004.

(51) Int. Cl. B32B 15/08; B32B 27/00; C08K 3/32; C08K 3/30; C08K 3/28

(52) U.S. Cl. 524/417; 428/421; 428/457; 524/423; 524/428

(57) ABSTRACT

Corrosion-inhibiting coating compositions which are self-priming topcoats having improved weatherability and durability are provided. The compositions contain fluorinated resins (binders), incorporate one or more corrosion-inhibiting compounds including corrosion-inhibiting extenders (a metal cation from Group I A or II A of the periodic table of the elements and an oxyanion counterion), corrosion-inhibiting rare earth compounds, and corrosion-inhibiting carbon pigments. Methods for applying the corrosion-inhibiting compositions to a substrate are also provided.

### CROSS-REFERENCE TO RELATED APPLICATIONS

The present Application claims the benefit of U.S. provisional patent application 60/536,950, titled “Direct To Substrate Coatings,” filed Jan. 16, 2004; the contents of which are incorporated in this disclosure by reference in their entirety.

### BACKGROUND

Metal substrates such as aluminum, steel, and other alloys used on industrial and consumer products, including appliances, automobiles, and aircraft, are subject to corrosion, also referred to as oxidation and rust. Corrosion can significantly reduce the useful life of these products. Various compositions are used to coat substrates, protecting the substrates from corrosion, and also enhancing performance. Coating compositions that impart corrosion resistance when applied to a metal substrate are known. A discussion of these coating compositions can be found in U.S. Pat. Nos. 6,312,812; 6,217,674; 5,866,652; 5,594,369; 5,041,241, 4,687,595; 4,459,155; and 4,405,493, and B. R. W. Hinton, Metal Finishing, 89 [9] 55-61 (1991); D. R. Arnott, Cationic-Film-Forming Inhibitors for the Protection of the AA 7075 Aluminum Alloy Against Corrosion in Aqueous Chloride Solution; M. S. Abdel-Aal, Proceedings of the 8^{th} European Symposium on Corrosion Inhibitors, Sez. V, Suppl. N. 10, (1995); V. Hluchan, Werkstoffe and Korrosion, 39, 512-717 (1998); M. A. Abdel-Rahim, Mat.-wiss. U. Werkstoffiech, 28, 98-102(1997); and Z. Lukacs, Proceedings of the 8^{th} European Symposium on Corrosion Inhibitors, Sez. V, Suppl. N. 10, (1995). These compositions suffer from the disadvantages such as having limited corrosion resistance, and/or have components such as chromates that have raised concern over their environmental impact or human toxicity.

Currently known corrosion resistant coating compositions are typically applied directly to a substrate in the form of a conversion treatment or a primer coating. A second coating composition, also referred to as a topcoat, is then applied to provide a decorative finish coat and to further protect the substrate and primer coating. This two-step coating process can be labor intensive, and require an extended curing/drying time. Topcoats are generally not applied directly to a substrate without an intermediate polymeric coatings because topcoat compositions can suffer from the disadvantages of not sufficiently adhering to the underlying substrate to provide adequate weathering resistance and durability and/or not providing the same corrosion resistance of conventional inter-polymeric or primer plus topcoat systems.

There is a constant economic need to minimize the production time and costs of manufactured consumer and industrial parts and goods. In the military industry, there is a need to increase the readiness of military aircraft and other vehicles by minimizing the production time required to maintain existing manufactured parts and goods. In the aerospace industry, there is a need to reduce aircraft weight for cost savings and to provide a strategic advantage for military aircraft.

Therefore, for the foregoing reasons, there is a need for a lighter weight coating composition that provides weathering resistance and durability, as well as the corrosion resistance necessary to provide protection to the underlying substrate, and minimizes the time and costs of producing and maintaining consumer and industrial parts and goods. It would also be advantageous if this coating composition were chromium free.

### SUMMARY

According to the present invention a corrosion-inhibiting coating composition comprising a fluorinated binder and a corrosion-inhibiting compound. The coating composition is capable of binding to an underlying substrate without an intermediate polymeric coating and capable of providing corrosion protection to the underlying substrate. There coating compositions according to the present invention are also referred to herein as enhanced self-priming topcoat compositions. In a preferred embodiment, the corrosion-inhibiting compound is one or more of a corrosion-inhibiting extender, a corrosion-inhibiting rare earth compound, and a corrosion-inhibiting carbon pigment. In another preferred embodiment, the fluorinated binder is a fluorinated organic polymer such as a fluorinated vinyl ether. The coating composition can also contain one or more additives and co-inhibitors that enhance weatherability and/or durability, and/or the corrosion inhibiting properties of the coating.

The rare earth compound can be one or more of rare earth oxides, rare earth hydroxides, mixtures of rare earth oxides, mixtures of rare earth hydroxides, solid solution mixed rare earth oxides, rare earth salts, and combinations thereof. Preferably, the rare earth compound is one or more of praseodymium oxides, praseodymium hydroxides, praseodymium solid solution mixed oxides, a mixture of praseodymium oxides, a mixture of praseodymium hydroxides, praseodymium nitrate, praseodymium sulfate, praseodymium phosphate, and combinations thereof.

The corrosion-inhibiting carbon pigment is a an effective amount of a carbon pigment which enhances the corrosion resistance properties of a carbon pigment-containing composition, as compared to a similarly formulated non-carbon pigment containing coating composition, such as a surface or pH modified carbon pigment.

The corrosion-inhibiting extender is a metal cation such Group IA and IIA metals, yttrium, lanthanides, and combinations thereof and a corresponding oxyanion (meaning those anions having an oxygen combined with another nonmetal), such as metal sulfates, phosphates, nitrates, and silicates, and combinations thereof.

The coating composition can also contain a co-inhibitor such as amine containing compounds, sulfur containing compounds, phosphorus containing compounds, polyaniline, ionic exchange resins, amino acids, derivatives of amino acids, dextrins, cyclodextrins, and combinations thereof.

According to the present invention, there is also provided a substrate coated with a corrosion-inhibiting coating composition. Preferably, the substrate is aluminum, aluminum alloys, bare steel, galvanized steel, zinc, zinc alloys, magnesium, magnesium alloys, and composite materials.

According to the present invention, there is also provided a method for coating a substrate comprising pretreating the substrate with a conversion treatment, applying a corrosion-inhibiting coating composition to the pretreated substrate, and curing the applied composition. Preferably, the conversion treatment is a cerium conversion coating, a praseodymium conversion coating, a phosphate conversion coating, a zinc-type conversion coating, an anodized coating, and anodized and sealed coating, and a chromium conversion coating.

According to the present invention, there is also provided a method for coating a substrate comprising preparing a coating base, the coating base having a fluorinated binder and one or more corrosion-inhibiting compounds, adding a catalyst to the coating base to form a mixture, and applying the mixture to the substrate.

According to the present invention, there is also provided a method for coating a substrate comprising applying a corrosion-inhibiting coating having a fluorinated binder and one or more corrosion-inhibiting compounds directly to a substrate without an intermediate polymeric coating between the substrate and the corrosion-inhibiting coating.

### DESCRIPTION

According to the present invention, there is provided a corrosion-inhibiting coating composition that can be used as a self-priming topcoat, that is, a coating applied directly to a substrate without an inter-polymeric coating or primer. These corrosion-inhibiting coating compositions contain a fluorinated binder, more specifically a functionalized fluorinated resin (binder), and when used as a self-priming topcoat, have improved weatherability and durability. The corrosion resistance of these enhanced self-priming topcoat (ESPT) formulations, also referred to as enhanced direct to substrate coatings, is significantly improved by incorporating corrosion-inhibiting compounds such as rare earth elements, corrosion-inhibiting carbon pigments, and corrosion-inhibiting extenders into the fluorinated binder. These corrosion-inhibiting compounds are further described in U.S. application Ser. No. 10/346,374, entitled “Corrosion Resistant Primer Coatings Containing Rare Earth Compounds for Protection of Metal Substrates” filed on Jan. 17, 2003; United States Application Ser. No. 10/758,972, entitled “Corrosion Resistant Coatings”; filed on Jan. 16, 2004; and U.S. application Ser. No. 10/758,973, entitled “Corrosion Resistant Coatings Containing Carbon”; filed on Jan. 16, 2004, which are hereby incorporated by reference in their entirety.

The enhanced self-priming topcoats according to the present invention reduce the coating process from a two-step, primer and topcoat application process to a one-step, direct to substrate coating application. Using the enhanced self-priming topcoat results in cost savings for materials and labor, and time savings by eliminating the curing/drying time for the inter-polymeric coating or primer. Further, a single direct to substrate coating results in a significant reduction in the weight of the coated substrate as compared to a substrate coated with both a primer and topcoat. Accordingly, the above-identified needs are satisfied by providing a coating composition that imparts corrosion protection to underlying substrates without the need for intermediate polymeric coatings or primers. The coatings also sufficiently adhere directly to an underlying substrate to provide a self-priming topcoat with orders of magnitude better weathering resistance and durability as compared to currently known compositions. Further, certain embodiments of the invention are chromate-free and allow for improved corrosion resistance that meets or exceeds the corrosion resistance for inter-coat polymeric coating or primer plus topcoat systems.

As used herein, the following terms have the following meanings.

The term “additive” means a solid or liquid component admixed with a polymeric material for the purpose of affecting one or more properties of a cured coating composition.

The term “catalyst” or “curing agent” means an additive that allows for the curing mechanism to begin when mixed together with the appropriate base.

The term “coating” means a polymeric material (organic or inorganic) that can be applied either as a liquid (e.g., paint) or solid (e.g., powder) to a substrate to form a polymeric film. Such polymeric materials include, but are not limited to, powder coatings, paints, sealants, conducting polymers, sol gels, silicates, silicones, zirconates and titanates.

The term “conversion coating”, also referred to herein as a “conversion treatment”, means a treatment for the metal surface of a substrate which causes the metal surface of the substrate to be chemically converted to a different material.

The term “conversion coated substrate”, also referred to herein as a “conversion treated substrate”, means a substrate treated with a conversion coating.

The term “corrosion-inhibiting carbon pigment” means an effective amount of a carbon pigment that enhances the corrosion resistance properties of a carbon pigment-containing composition, as compared to a similarly formulated non-carbon pigment containing coating composition.

The term “corrosion-inhibiting extender” means a compound having a metal cation in Group I A or II A of the periodic table of the elements, and an oxyanion counterion.

The term “corrosion-inhibiting rare earth compound” means a corrosion-inhibiting compound having a rare earth element (i.e., an element in Group IIIB of the periodic table of the elements and yttrium).

The term “enhanced self-priming topcoat”, also referred to as an “enhanced direct to substrate coating” means a coating applied directly to a substrate without an inter-polymeric coating or primer, comprising one or more fluorinated binders.

The term “fluorinated binder” means a film-forming ingredient of a coating composition comprising a fluorinated polymeric material.

The term “mixed oxide” means a solid solution of a single element having multiple oxidation states and a mixture of oxides does not fall within this meaning.

The term “pigment” means a solid particle admixed with a polymeric material that, as the material cures, is incorporated into the final coating and provides volume to the resulting final coating.

The term “pigment volume concentration”, or “PVC” is the ratio of the volume of pigment (including extenders, corrosion-inhibiting rare earth compounds, and corrosion-inhibiting carbon compounds) to the volume of total nonvolatile material, i.e., pigment and binder, in the final film, expressed as a percentage.

The term “polymeric resin” means an organic based polymer used to incorporate inhibitors into a liquid polymeric material. A “polymeric resin” is typically considered a type of binder.

The term “self-priming topcoat”, also referred to as a “direct to substrate coating”, means a coating applied directly to a substrate without an inter-polymeric coating or primer.

The term “substantially soluble” means a solubility level of more than about one (1) mole per liter of water (mol/L),

The term “not substantially soluble” means a solubility level of less than about one (1) mol/L.

The term “substrate” means a material having a surface that can be cleaned and/or protected and/or modified to provide unique properties. A “substrate” is not limited to any particular type of material, although in terms of applying a corrosion inhibiting coating, such substrates are typically metal, but may also include polymeric substrates, polymeric coated metallic substrates, composite substrates, such as a substrate made with carbon fibers and epoxy resin.

The term “weight percent” (wt %) when used without qualification, refers to the weight percent of a particular solid component, e.g., pigment, extender, etc., as compared with all solid components present, excluding polymeric resins. For example, if the only solid component present in the coating is a corrosion-inhibiting carbon pigment, the corrosion-inhibiting carbon pigment is considered to have a wt % of 100. The weight percent of two or more components is dependent on the densities of those components.

The term “comprise” and variations of the term, such as “comprising”, “comprises”, and “comprise”, are not intended to exclude other additives, components, integers, or steps.

In the following description, embodiments are described in sufficient detail to enable those skilled in the art to practice the invention. Other embodiments may be utilized and structural, logical and other changes may be made without departing from the spirit and scope of the present invention. The following description is, therefore, not to be taken in a limiting sense.

In one embodiment, the coating composition is an enhanced self-priming topcoat coating composition comprising a fluorinated binder and a corrosion-inhibiting compound. The enhanced self-priming topcoat (ESPT) coating composition, also referred to herein as an enhanced direct to substrate coating, is applied directly to a substrate without an inter-polymeric coating or primer. The ESPT coating composition comprises one or more fluorinated binder, such as a fluoroethylene-alkyl vinyl ether, in whole or in part with other binder(s), which can be an organic or inorganic based polymer or blend of polymers. The coating composition is capable of binding to an underlying substrate without an intermediate polymeric coating and capable of providing corrosion protection to the underlying substrate.

The fluorinated binders, also referred to herein as fluorinated resins are fluorinated polymeric materials known to those of skill in the art. The fluorinated binders utilized herein can be either inorganic or organic include those soluble in water and those soluble in non-aqueous systems and powder coating systems. In one embodiment, film-forming polymers that crosslink upon curing are used. Examples of fluorinated binders that can be used according to the present invention include, but are not limited to fluorinated polymers, such as fluorinated epoxy, urethane, urea, acrylate, alkyd, melamine, polyester, vinyl, vinyl ester, vinyl ether, silicone, siloxane, silicate, sulfide, sulfone, amides, epoxy novilac, epoxy phenolic, amides, amines, drying oils, hydrocarbon polymers, including combinations and co-polymers thereof, as well as derivatives of the forgoing fluorinated polymers, such as fluorinated polymers having one or more functional groups including for example, alkyl, alkylate, alkyloate, alkoxy, alkylene, halogen, hydroxyl, nitrile, phenyl, and pyridyl. For optimum weather resistance and durability, as well as other desired properties, a preferred but not required fluorinated binder is a fluorinated vinyl ether, such as a fluoroethylene-alkylvinyl ether. However, other fluorinated polymers can be used in the corrosion-inhibiting compositions described herein as will be understood by those of skill in the art with reference to this disclosure.

Known corrosion-inhibiting compounds, as discussed herein, can be combined with fluorinated binders to form a corrosion-inhibiting coating composition. The precise amount of corrosion-inhibitive compounds, including extenders, carbon-pigments, rare earth compounds, additives and/or additional co-inhibitors that is considered an effective corrosion-inhibiting amount may vary considerably depending on the type of compounds used, the level of corrosion resistance desired, and the type of substrate. Generally, if too little corrosion inhibitor is added, there will not be sufficient corrosion inhibition in the coating. If too much corrosion inhibitor is added, the liquid polymeric material will become too viscous to use or even become a solid. Care must be taken not to exceed the critical pigment volume concentration (CPVC) of the system.

In one embodiment the corrosion inhibitor(s) (including extenders, corrosion-inhibiting rare earth compounds, corrosion-inhibiting carbon compounds, co-inhibitors, and additives) is added to the fluorinated polymeric material in a pigment volume concentration (PVC) of about 0.1 to about 65. However, in some embodiments it is possible that the PVC may be greater than 65. The corresponding wt % can vary considerably, depending on the density of the corrosion inhibitor(s) being used. In one embodiment, a PVC range of about 0.1% to about 65% for the corrosion inhibitor(s) corresponds with a weight percent of about 0.1 wt % to about 100 wt % the solid components present in the composition. In another embodiment, a PVC range of about 0.1% to about 65% corresponds with a weight percent of a corrosion inhibitor(s) of about 3 wt % to about 75 wt % of the solid components present in the composition.

PVC is a method of describing pigment proportion in coatings. PVC does not account for the volume fraction of air voids in the film. With increasing PVC the binder volume in the final film keeps decreasing. PVC influences the properties of the coating composition and more so as it approaches a point where there is just enough binder to maintain a continuous phase. This point is termed the critical pigment volume concentration (critical PVC, or CPVC, discussed below). Beyond the CPVC, there is not enough binder to fill the voids between pigment particles, and the binder phase becomes discontinuous, leading to air voids in the coating. Coating properties alter sharply around the CPVC. For instance, properties such as gloss, enamel hold-out, adhesion, blistering, corrosion resistance, and mechanical properties such as tensile strength decrease beyond the CPVC, while porosity, rusting, dry hiding, and stain susceptibility increase above the CPVC. In general, therefore, coatings are formulated below the CPVC level.

In a preferred but not required embodiment, the corrosion-inhibiting compound is a corrosion-inhibiting extender. A corrosion-inhibiting extender is a compound having a metal cation from Group I A or II A of the periodic table of the elements, yttrium, or a lanthanide and an oxyanion (meaning those anions having an oxygen combined with another nonmetal) counterion. Preferred oxyanions include acetates, borates, carbonates, nitrates, phosphates, phosphonates, sulfates, triflates, silicates and EDTA. More preferred corrosion-inhibiting extenders include, phosphates, nitrates, and silicates.

Corrosion-inhibiting extenders are “acidic generating extenders” and “neutral to slightly acidic generating extenders”. These extenders can be used alone or in combination with other components to generate a pH environment of between about 4 to about 8, for the neutral to slightly acidic extenders, and between about 2 and about 4 for the acidic generating extenders, in a coating composition (with the pH of the coating composition determined by standard methods and concentrations known to those of skill in the art).

A neutral to slightly acidic generating extender can itself be acidic, neutral or basic (e.g., Na₂HPO₄) and can also add extender properties to the coating composition. In most instances, a neutral to slightly acidic generating extender does not substantially solubilize in the coating composition, thereby adding volume to the composition. Examples include oxyphosphorous compounds, and some Group IIA sulfates, such as calcium sulfate, and strontium sulfate. Included within this term are neutral to slightly acidic generating extenders, i.e., additives, which are substantially soluble and therefore do not add volume to the composition. Examples include certain sulfates known in the art to not be useful in adding volume but which have shown surprisingly good results as corrosion inhibitors, such as magnesium sulfate.

The precise amount of neutral to slightly acidic generating extender needed to generate the desired pH in the composition will vary depending on the type and amount of binders, solvents, pigments and other additives, including other types of extenders present in the coating composition. An acidic generating extender can itself be acidic or neutral and can also add extender properties to the coating composition. Examples of acidic generating extender compounds that are capable of generating a pH environment of between about 2 to about 4 include, but are not limited to certain hydrogen sulfates such as Ca(HSO₄)₂. Neutral to slightly acidic generating extenders include compounds that are substantially soluble, not adding volume to the composition. It is possible that the same compound can be properly categorized as an “acidic generating extender” and a “neutral to slightly acidic generating extender”, depending on the pH it has generated in a particular coating composition. One example of a compound that can generate a pH in either range includes CaHPO₄. The precise amount of acidic generating extender needed to generate the desired pH in the composition will vary depending on the type and amount of binders, solvents, pigments and other additives present. The corrosion-inhibiting extenders according to the present invention are further described in U.S. application Ser. No. 10/346,374; and U.S. application Ser. No. 10/758,972, entitled “Corrosion Resistant Coatings”; filed on Jan. 16, 2004, and can be used according to the present invention as will be understood by those of skill in the art with reference to this disclosure.

Extenders can serve as a cost effective substitute for coloring pigments such as titanium dioxide, as well as providing the desired pigment to binder ratios for the coatings. In a most preferred but not required embodiment, the corrosion-inhibiting extender is one or more of a metal cation sulfate such as, for example, calcium sulfate, calcium sulfate dihydrate, strontium sulfate, magnesium sulfate. These extenders appear to assist in the activation of inhibitors that may be present in the environment (e.g., in previously applied conversion coatings, in the polymeric coating itself, etc.), thus enhancing the corrosion resistance of the protective coating.

The amount of extenders used in the coating compositions can vary considerably. In one embodiment, extenders are added in a weight percent of about 0.1 to 100% of the total amount of extenders. In a preferred but not required embodiment, about 45 to 75 wt % of a corrosion-inhibiting extender is used, although the invention is not so limited. In another embodiment, about 0.1 to 3 wt % of one or more types of magnesium sulfate is used.

In another preferred but not required embodiment, the corrosion-inhibiting compound is a rare earth compound. A rare earth compound is a compound having a rare earth element (i.e., an element in Group IIIB of the periodic table of the elements, that is, elements 57-71 and Yttrium). Examples of rare earth compounds according to the present invention include, rare earth oxides, mixed oxides, solid solution oxides, hydrated oxides, salts, triflates, complexes, such as rare earth complexes using ethylenediamine tetraacetic acid, organic exchange resins, and combinations thereof. The coating may contain 0.1-95 wt % of a rare earth compound. (In this instance the wt % is in reference to the total wt % of all pigments present in the coating). In one embodiment, the coating contains about 0.4 to 26 wt %, of a rare earth compound. In a preferred but not required embodiment, the rare earth compounds are based on any of the lanthanide series, such as praseodymium, cerium and terbium in particular. In a more preferred but not required embodiment, the rare earth compound is an oxide, mixed oxide, or hydroxide such as Y₂O₃; La₂O₃, CeO₂, Pr(OH)₃, PrO₂, Pr₂O₃, Pr₆O₁₁, Nd₂O₃, Sm₂O₃, Tb₄O₇, and Yb₂O₃, for example. The oxidation state of the rare earth metal employed is also an important consideration when choosing a rare earth compound as a particular corrosion-inhibiting compound. In a most preferred but not required embodiment, the rare earth compound is a praseodymium(III), praseodymium(III/IV), and/or a praseodymium(IV) compound, in particular PrO₂, Pr₂O₃, and Pr₆O₁₁. The preferred oxidation states of the rare earth compounds may also be a function of the final coating system employed in a particular application. Corrosion-inhibiting rare earth compounds are further described in aforementioned U.S. application Ser. No. 10/346,374, entitled “Corrosion Resistant Primer Coatings Containing Rare Earth Compounds for Protection of Metal Substrates” filed on Jan. 17, 2003; and U.S. application Ser. No. 10/758,972, entitled “Corrosion Resistant Coatings”; filed on Jan. 16, 2004, and can be used according to the present invention as will be understood by those of skill in the art with reference to this disclosure.

In another preferred but not required embodiment, the corrosion-inhibiting compound is a corrosion-inhibiting carbon pigment. The term “carbon pigment” refers to a wide variety of carbon containing compounds that can be either elemental carbon or a carbon-containing mixture. However, for the purposes of this disclosure, the term “corrosion-inhibiting carbon pigment” is an effective amount of a carbon pigment that enhances the corrosion resistance properties of a carbon pigment-containing composition, as compared to a similarly formulated non-carbon pigment containing coating composition. Carbon pigments can be used in paints and coatings to affect certain specific physical properties of the coating such as coloration, dispersion and mixing properties, conductivity, and light absorbtivity. Further discussion of the use of carbon in coatings can be found in U.S. Pat. Nos. 6,506,889; 6,506,245; 6,457,943; 6,312,812; and 5,996,500. With regard to elemental carbon, the carbon pigment can be in many forms, such as crystalline (e.g., graphite), amorphous, partially crystalline or amorphous, i.e., quasi-graphitic forms, “Fullerenes” and any other form of carbon known in the art (amorphous carbon is often considered to be a finely divided graphite or quasi-graphitic material). A “carbon pigment” as referred to herein is not necessarily predominantly carbon. For example, bone black (also referred to as “bone ash” and “ivory black”, which is a carbon pigment made by carbonizing bones) is a carbon mixture that actually contains only about 10% carbon, with the remaining portion being calcium phosphate. The various carbon pigments are made by a variety of known manufacturing processes, which impart unique characteristics to the end product. It is further understood that not all carbon pigments are corrosion-inhibiting carbon pigments.

Carbon blacks, a form of carbon-pigment, can also be incorporated into paints and coatings for a number of different reasons as noted above. Carbon blacks are generally categorized as acetylene black, channel black, furnace black, lampblack or thermal black, and the surface-modified variations thereof, according to the process by which they are manufactured. Types of carbon black can be characterized by the size distribution of the primary particles, the degree of their aggregation and agglomeration and the various chemicals adsorbed onto the surfaces. An average primary particle diameter in several commercially produced carbon blacks range from between about 10 nm to about 400 nm, while average aggregate diameters range from between about 100 nm to about 800 nm. In some instances, those skilled in the art equate carbon black with other terms, such as activated carbon, and animal charcoal, such as Norit™ (Norit Americas Inc., Atlanta, Ga.) and Ultracarbon™ (Ultracarbon, Neidernhausen, Germany). It is not intended to limit any reference herein to “carbon black” to any one specific type of material. Different forms of carbon blacks such as lamp black, gas black, and furnace black, all have some properties in common, but also each form has properties unique to the particular processing method used to make the carbon black. These properties include variations in tinting strength, pH, oil adsorption, and structure for example, which can influence the physical properties of a coating composition. Other types of carbon blacks referred to (e.g., graphite, amorphous carbon, crystalline carbon, activated carbon, conducting carbon, nonconducting carbon, bone black, and so forth) also have their own unique processing methods and, as a result, have properties unique to that method.

Corrosion-inhibiting carbon pigments according to the present invention include various forms of carbon pigments and carbon blacks, such as crystalline forms (e.g., graphite), amorphous forms (e.g., activated carbon, conductive carbon, non-conductive carbon, animal charcoal, and decolorizing carbon), inorganic-dispersed carbon pigments, carbon spheres, surface-modified carbon pigments (e.g., Raven™ 1040, Raven™ 1250, Raven™ 1255, 5000 Ultra II, available from Columbian Chemicals Co., Marietta, Ga.), surfactant and/or resin-dispersed carbon pigments (e.g., Sun Chemical carbon dispersions such as LHD-9303: Sunsperse™ Carbon Black Dispersion, U47-2355: Polyversyl™ Flushed Color, PLD-2070: Specialty Carbon Black Dispersion, etc., Sun Chemical (The Colors Group), Cincinnati, Ohio), bone blacks (e.g., Ebonex pigments, such as Cosmic Black 7, a bone black pigment, Ebonex Inc., Melvindale, Mich.), and combinations thereof. Bone black contains only approximately 10% carbon, with the remaining content being primarily calcium phosphate, making it a particular carbon compound of interest.

In a preferred but not required embodiment, the corrosion-inhibiting carbon pigment is a “surface-modified carbon pigment” which refers to an engineered carbon pigment modified to generate differences in characteristics such as aggregation, porosity, particle size, surface area, surface chemistry, physical form and size distribution. These chemical and physical properties influence surface reactivity and can be varied to achieve the desired properties for a particular coating application. Other corrosion-inhibiting carbon pigments are further described in aforementioned U.S. application Ser. No. 10/858,053, entitled “Corrosion Resistant Coatings Containing Carbon”; filed on Jan. 16, 2004, and can be used according to the present invention as will be understood by those of skill in the art with reference to this disclosure.

Co-inhibitors known in the art can also optionally be employed in the present invention together with the corrosion-inhibiting extenders, corrosion-inhibiting rare earth compounds, and/or corrosion-inhibiting carbon pigments. Co-inhibitors can be used to control the local environment near the substrate interface and can also be used for corrosion protection. For example, local pH and ionic activity can be modified in a favorable way using various pigments with an inherent or surface modified pH characteristic or by using ionic exchange resins. Such co-inhibitors include, for example, metal oxides, borates, metaborates, silicates, phosphates, phosphonates, aniline, and polyaniline. Other co-inhibitors may also be optionally employed in the present invention, such as Nalzan™ (NL Industries, Highstown, N.J.), Busan™ (Buckman Laboratories, Memphis Term.), Halox™ (Halox Inc., Hammond, Ind.), Molywhite™ (Sherwin Williams Inc., Coffeyville, Kans.). However, other co-inhibitors that are chemically compatible with the corrosion-inhibiting coating compositions can be used, as will be understood by those of skill in the art with reference to this disclosure.

Additives that provide corrosion inhibition can also optionally be employed in the present invention together with the corrosion-inhibiting extenders, corrosion-inhibiting rare earth compounds, and/or corrosion-inhibiting carbon pigments and, optionally, any other additives described herein. An example of an additive includes a surfactant that assists in wetting pigments as is known in the art. Other additives can assist in the development of a particular surface property, such as a rough or smooth surface. Examples of suitable additives include surfactants, silicon matting agents, which are also noted above in reference to a “pigment”, dyes, amino acids, and the like. In one embodiment, amino acids are used as an additive. Amino acids and/or other additives useful in the present invention include, but are not limited to glycine, arginine, methionine, and derivatives of amino acids, such as methionine sulfoxide, methyl sulfoxide, and iodides/iodates, gelatin and gelatin derivatives, such as animal and fish gelatins, linear and cyclic dextrins, including alpha and beta cyclodextrin, triflic acid, triflates, acetates, organic-based ionic exchange resins, such as organic-based cationic and anionic exchange resins, organic-based ionic exchange resins which have been pre-exchanged or reacted with a rare earth compound. In one embodiment, the additives comprise between about 0.03 wt % to about 5 wt % of the solid components in the polymeric material. In another embodiment, the additives comprise between about 0.1 wt % to about 1.2 wt % of the solid components in the coating. In another embodiment, the coating contains between about 0.03 wt % to about 5 wt % of complexing linear and cyclic dextrins, gelatin, gelatin derivatives and combinations thereof. Of particular interest are arginine, methionine, gelatin and the exchange resins, their success being somewhat dependant on the polymer material being employed.

Ionic exchange resin can be employed as a complexing agent for the corrosion-inhibitor and can be neutral, cationic or anionic in nature, although both cationic and anionic can be used in the same self-priming or enhanced self-priming formulations. In one embodiment, the ionic exchange resin comprises between about 0.1 wt % to about 7 wt % of the solid components in the coating. In a preferred but not required embodiment, the ionic exchange resin comprises between about 0.5 wt % to about 3 wt % of the solid components in the coating. The ionic exchange resin can further contain rare earth ionic forms and/or amino acids. In another preferred but not required embodiment, the ionic exchange resin comprises rare earth ion forms, amino acid, amino acid derivative, amine-based complex of a rare earth compound, and combinations thereof, in an amount that is between about 0.1 wt % to about 5 wt % of the solid components in the polymeric material. In a more preferred but not required embodiment, this amount is between about 0.5 wt % to about 1.5 wt %.

The coating compositions of the present invention can optionally also contain color pigments. In general, the color pigment is incorporated into the coating composition in amounts of between about 0.1 wt % to about 80 wt %, usually about one (1) to 30 wt % based on total weight of the coating composition (in contrast to wt % of just the solid components as defined herein). In a preferred but not required embodiment, the optional pigments comprise up to approximately 25 wt % of the total weight of the coating composition. Color pigments conventionally used in surface coatings include inorganic pigments such as titanium dioxide, iron oxide, carbon black, phthalocyanine blue and phthalocyanine green, for example. Metallic flake pigmentation is also useful in self-priming or enhanced self-priming topcoat compositions of the present invention. Suitable metallic pigments include aluminum flake, zinc, copper bronze flake, and metal oxide coated mica. However, other pigments can be used in the coating compositions according to the present invention, as will be understood by those of skill in the art with reference to this disclosure.

Additional additives and pigments can be employed to provide desired aesthetic or functional effects. These optional materials are chosen as a function of the coating system and application and can include flow control agents, thixotropic agents (e.g., bentonite clay), anti-gassing agents, organic co-solvents, catalysts, and other customary auxiliaries. However, other optional materials known in the art of formulated surface coatings can be used in the coating compositions according to the present invention, as will be understood by those of skill in the art with reference to this disclosure.

Use of carbon, silicates, etc. to modify the surface of the carbon pigment and other corrosion inhibitors is also possible, as will be understood by those of skill in the art with reference to this disclosure. Specifically surface modified pigments blend into the polymeric material more easily. Additionally, the particular manner in which the surface has been modified can also play a role.

The actual particle size of the extenders and/or other corrosion inhibiting particles can also play a role in improving corrosion resistance, with smaller particles providing improved resistance. As a result, grinding the pigments to a specific particle size can enhance corrosion resistance.

Additionally, use of pre-dispersants, described herein, can also play a role in enhancing corrosion resistance.

With respect to the total amount of all types of added pigment, there is a point, known as the critical pigment volume concentration (CPVC) above which the coating will not properly function. However, below this level, any desired amount of pigment can be added, and such amount is often referred to as a total PVC, as discussed above. In certain embodiments, it may be important to stay below the CPVC sufficiently to provide an optimum composition. In one embodiment, the total PVC ranges from about 5 to about 55. The preferred PVC ranges from about 20 to about 40. The total PVC range can correlate with an almost limitless range of pigment content based on weight. In one embodiment, the weight percent of a single pigment present in a self-priming or enhanced self-priming topcoat, e.g., a metal sulfate pigment, ranges from about 0.1 to 100 wt %, as discussed above. More preferred ranges will depend on many factors, such as the type of pigment used, the degree of corrosion resistance required, the self-priming or enhanced self-priming topcoat formulation being employed, the surface being treated, and so forth.

According to the present invention, the coating composition can contain a combination of corrosion-inhibiting compounds, and one or more co-inhibitors, and/or additives. In a preferred but not required embodiment, between about 0.1 to about <100% of a rare earth compound or blend of rare earth compounds is used as a co-inhibitor(s) in conjunction with a corrosion-inhibiting extender.

In another embodiment, the corrosion-inhibiting coating composition according to the present invention is applied to a substrate. The corrosion-inhibiting coating compositions can be applied to substrates that are metal substrates, such as aluminum, aluminum alloys, magnesium, magnesium alloys, titanium, zinc, zinc-coated steel, zinc alloys, zinc-iron alloys, zinc-aluminum alloys, bare and galvanized steel, stainless steel, pickled steel, iron compounds, copper, bronze, substrates having metal pretreatments, such as chrome-based conversion coatings, anodized coatings, cobalt-based conversion coatings, phosphate-based conversion coatings, silica-based conversion coatings, rare earth-based conversion coatings, and stainless metal pretreatments for example. Other metal treatments include sol-gel technologies, coatings formed using X-It Prekote, (Pantheon Chemicals, Phoenix, Ariz.). The substrate can also be a composite material such as polymers, polymer/metal composites, composites, coated substrates, and the like, or the substrate can be a polymeric coating or primer. The substrate can also be a coating system comprising one or more pretreatment coatings applied to a substrate to form a pretreated substrate.

In a preferred but not required embodiment, the corrosion-inhibiting coating composition is applied over a pretreated substrate where the pretreatment is a conversion coating, also referred to herein as a conversion treatment. Examples of conversion coatings onto which the coatings of the present invention can be applied include rare earth element containing conversion coatings (e.g., cerium conversion coatings (CeCC) and praseodymium conversion coatings (PrCC)), phosphate conversion coatings, zinc-type conversion coatings and preferably, chromium conversion coatings (CrCC). Examples of conversion coatings include Alodine™ chrome and non-chrome conversion coatings made by Henkel Surface Technologies, Madison Heights, Mich. (e.g., Alodine™ 1000, 1200, 1200S and 2000). Other examples of CrCC that can be used include those made using an Iridite™ pocess from MacDermid, Inc., Waterbury, Conn. (e.g., Iridite™ 14.2). Other examples of CrCC include chromic acid anodized with chrome seal and sulfuric acid anodized with chrome seal. Examples of rare earth element containing conversion coatings include those disclosed in U.S. patent application Ser. No. 11/002,8741, titled “Corrosion Resistant Conversion Coatings,” incorporated herein by reference in its entirety.

Applying the corrosion-inhibiting coating composition over a conversion coating has been found to maintain good adhesion of the coating to the substrate. The age and thickness of the applied conversion coatings may influence the corrosion resistance of the subsequent paint coatings. It has also been found that conversion coatings that are too thick for a given application can result in cohesive failure in the conversion coating layer. Preferably, self-priming or enhanced self-priming coatings are applied over a conversion coating that is less than three days old and preferred coatings comply with MIL-C-5541. However, the proper conversion coating thickness for a particular self-priming or enhanced self-priming coating will be apparent to those of skill in the art with reference to this disclosure.

In another embodiment, the corrosion-inhibiting coating composition is a solvent borne coating composition applied as a liquid (e.g., a paint) to the substrate. Suitable types of solvent can be determined by those of skill in the art. It is preferable, but not required, that the solvent is an organic based solvent or mixture of solvents. In another embodiment, corrosion-inhibiting coating composition is applied in powder or paste form (e.g., a solgel) to the substrate. In yet other embodiments, the coating is a sealant, or a conducting polymer.

In a more preferred but not required embodiment, a chrome conversion coating is used on the substrate together with a corrosion-inhibiting coating composition containing one or more rare earth compounds and a hydrated sulfate extender.

In another aspect of the invention, a method for preparing and using the self-priming topcoat composition, or the enhanced self-priming topcoat composition is provided. According to this method, conventional methods for manufacturing a paint can be used. Examples of such methods include, but are not limited to, the use of drill presses powered by compressed air or electricity, and sand mills that use appropriate grinding media, as will be understood by those of skill in the art with reference to this disclosure.

According to a preferred but not required method, first, a base for the corrosion-resistant coating composition is prepared. The base is prepared by dispersing one or more binders, one or more pigments, solvent if needed, and a curing agent. The base is dispersed in an appropriately sized container at 650 rpm using a dispersion blade, such as a standard dispersion blade and standard dispersing equipment or a drill press, as is known in the art. Under agitation at an appropriate speed, such as about 600-700 rpm, coloring pigments, naturally occurring extenders, that is, minerals such as gypsum, and synthetic extenders, together with any other corrosion inhibitors are incorporated into the coating formulation. If an appropriate grinding media is desired, it can be added as needed. Next, once the material is properly added to the formulation, the base is allowed to disperse for a suitable time and speed, such as about five more minutes at 650 rpm. After this time, the dispersion speed can be increased as needed, such as to about 1600 to 1640 rpm until the desired mill base pigment grind is obtained. During dispersion at the higher speed, the temperature of the mill base can be monitored and kept below the recommended temperatures for the ingredients and resin systems used. If it appears that the mill base temperature is close to exceeding the recommended temperatures for the stability of the ingredients or resins, the dispersion speed can be reduced appropriately. If necessary, the dispersion process can be halted momentarily to allow proper cooling. As will be understood by those of skill in the art with reference to this disclosure, other steps, such as using cooling systems to minimize higher dispersion temperatures can additionally or alternatively be used. Also, as will be understood by those of skill in the art with reference to this disclosure, the solvent employed in the preparation of the coating system is chosen in such a manner as to facilitate the preparation of the coating mixture, to provide suitable application properties, and provide and environmentally acceptable paint.

Once the desired pigment particle size for the base grind is obtained, the dispersion process can be halted, and the base filtered, if desired, to remove any undesired material from the base, such as grinding media that can optionally have been used. Next, the balance of formula ingredients are added in a “letdown phase”, as it is known in the art, while the pigment base or mill base is mixed. An optional step is to allow the base or finished paint to set for at least twenty-four hours prior to use, which allows the resin to wet all of the pigments. The shelf life of the self-priming topcoat composition, or the enhanced self-priming topcoat composition prior to use is generally dictated by the time specifications provided by the supplier of the resin system.

The self-priming topcoat composition, or the enhanced self-priming topcoat composition is then prepared by adding appropriate amounts of a catalyst or activator, such as an isocyanate catalyst, into the finished base described above. Examples of isocyanate catalysts for self-priming topcoat or enhanced self-priming topcoat formulations include an isocyanate solution known as Deft 97GY088CAT (Deft Inc., Irvine, Calif.). To ensure proper curing and cross-linking of the resulting paint film, the amount of isocyanate catalyst added to the finished paint base can vary depending on the particular components of the coating system, as will be understood by those of skill in the art with reference to this disclosure.

Once the finished base and catalyst have been mixed together, the coating is ready for application to a substrate. The substrate to be coated can be that of a fabricated article, such as aircraft, automobiles, trucks, and farm equipment, for example, as well as the components and parts for these articles. Preferably, the substrate or coated substrate is prepared prior to receiving the coating, that is, the substrate is pretreated. The pretreatment preparation can include a conventional method of first cleaning the surface to remove grease and other contaminants. Once the surface is cleaned, it can be treated to remove any oxide coating by conventional or other means, such as by immersing the substrate in a series of sequential chemical baths containing concentrated acids and alkalis known to remove such oxide coatings. As described herein, the substrate may then be treated to provide a conversion coating. Alternatively, the surface can be treated with a boric acid/sulfuric acid or another anodizing process. For example, when an aluminum containing substrate is used, this process produces a mixture of aluminum oxides on the surface of the aluminum containing aluminum alloy substrate. Optionally, after the surface has been conversion coated, the surface can be sealed by dipping the substrate into a dilute solution of chromic acid. The surface, whether sealed or unsealed, is then coated with a self-priming topcoat or enhanced self-priming topcoat composition described herein.

In one embodiment, the coating composition is applied to an aluminum anodized substrate to create an aluminum anodized system with and without sealing in a chrome containing solution. In another embodiment, the coating is applied to an aluminum anodized substrate to create an aluminum anodized system with and without sealing in a rare earth solution. In another embodiment, the coating is applied to a steel substrate with and without sealing in the appropriate solution.

The self-priming topcoat or enhanced self-priming topcoat coating compositions described herein can be applied to a substrate using any conventional technique, such as spraying, “painting” (e.g., with a brush, roller, and the like), and dipping, for example. With regard to application via spraying, conventional (automatic or manual) spray techniques and equipment used for air spraying and electrostatic spraying may be used. In other embodiments, the coating can be an electrolytic-coating (e-coating) system, or an electrostatic (powder) coating.

The self-priming topcoat or enhanced self-priming topcoat coatings described herein can be any suitable thickness, depending on the application requirements. It is preferred but not required that the coating is between about 1 millimeter to about 3 millimeters thick.

After application of the coating, the coating is typically cured using a suitable method. Typical curing methods include air drying, and/or heating and/or UV-curing methods. Other methods include microwave cured systems, and ultrasonic cured systems, for example. Suitable curing methods are determined by the type of coating mixture employed, the surface to which it is applied, and so forth, as will be understood by those of skill in the art with reference to this disclosure.

Once the coating composition is applied, it may be cured as a stand-alone coating. If the coating is to receive a subsequent topcoat, or several subsequent coatings, then the subsequent coating should be applied so as to be compatible with the coating layer already present, typically in accordance with the resin and/or topcoat manufacturers' specifications.

The invention will be further described by reference to the following non-limiting examples, which are offered to further illustrate various embodiments of the present invention. It should be understood, however, that many variations and modifications may be made while remaining within the scope of the present invention.

### EXAMPLE 1

### Enhanced Self-Priming Topcoat Composition

Enhanced self-priming topcoat coating compositions comprising a fluorinated resin and one or more Group I A or Group II A, and/or yttrium, and/or lanthanide compounds were prepared with the base formulation shown below in Table 1.

TABLE 1
Enhanced Self-Priming Topcoat Base Formulation

| | mass |
|---|---|
| Component | (g) |
| Polyester Resin Blend (binder) | |
| KFLEXSM-A307 ™ (King Industries, Inc., Norwalk, CT) | 130 |
| Fluorinated Resin Blend (binder) | |
| Lumiflow ™ 910-LM (ASAHI Glass Co., Toyoko, JP) | 119.6 |
| Methyl Amyl Ketone | 65.1 |
| Ektapro EEP ™ (Eastman Chemical, Kingsport, TN) | 33.9 |
| UV Absorbers/Stabilizers (Ciba, Basel, Switzerland) | 16.8 |
| Flow Modifiers (Ciba, Basel, Switzerland) | 3.4 |
| SC 100 | 1.2 |
| Dispersing Agent | |
| Disper byk 182 (BYK Chemie, Wesel Germany) | 5 |
| BYK P104S (BYK Chemie, Wesel, Germany) | 1 |
| Ketone Solvent | |
| Methyl Amyl Ketone | 53 |
| 2,4-Pentanedione | 24 |
| VOC Exempt Solvent | |
| p-chlorobenzotrifluoride | 5 |
| Color Pigments | 45 |
| Corrosion Inhibitive Pigments | 310 |
| Extender Pigments | 74 |
| Base Total: | 1000 |

### EXAMPLE 2

### Comparative Example

A. Primer Plus Topcoat Coating Compositions

Corrosion-inhibiting primer plus topcoat coating compositions were prepared with the formulations shown in Table 2 below. The coating compositions were prepared according to the manufacturers instructions.

Test samples 1-6 were prepared by spraying the coating onto individual metal substrates allowing the substrates to dry (cure) naturally over time for about one week. The edges and backs of test samples 1-6 were taped and the front surfaces were scribed with an “X” pattern according to ASTM B117 procedure. The results were evaluated according to the Keller Corrosion Rating Scale shown in Table 3 below. The 2000 hour salt fog rating score for the primer plus topcoat coating compositions are shown below in Table 2.

TABLE 2
Primer Plus Topcoat Formulations (Prior Art Example).

| | | | **Weight Percent | 2000 Hour |
|---|---|---|---|---|
| Sample | | | Corrosion Inhibitor | Salt Fog |
| Number | *Deft Primer | *Deft Topcoat | in Topcoat | Rating |
| 1 | 44GY030 | 99GY001 | None | 3, 6 |
| 2 | 44GY030 | 99GY001 | 9% Pr₆O₁₁ | 3, 6 |
| 3 | 44GY030 | 99W009 | None | 3, 5 |
| 4 | 44GY030 | 99W009 | 9% Pr₂O₃ | 3, 6 |
| 5 | 44GY030 | 99W009 | 9% CeO₂ | 3, 6 |
| 6 | 44BK016 | 99GY001 | 9% Pr₆O₁₁ | 3, 4 |

*Deft Primer and Deft Topcoat numbers refer to product identification numbers of primer and topcoat formulations, available from Deft Inc., having offices in Irvine, California.
**Weight percent inhibitor pigment based on total weight percent of fully catalyzed and sprayable topcoat.

TABLE 3
Keller Corrosion Rating Scale (Boeing-St. Louis), i.e., 1000 and 2000
Hours Salt Fog Ratings.

| | Scribe |
|---|---|
| Corrosion Activity: | Line Activity |
| 1. Scribe line beginning to darken or shiny scribe. | A. No creepage. |
| 2. Scribe lines >50% darkened. | B. 0 to 1/64″ |
| 3. Scribe line dark. | C. 1/64 to 1/32″ |
| 4. Several localized sites of white salt in scribe lines. | D. 1/32 to 1/16″ |
| 5. Many localized sites of white salt in scribe lines. | E. 1/16 to ⅛ |
| 6. White salt filling scribe lines. | F. ⅛ to 3/16″ |
| 7. Dark corrosion sites in scribe lines. | G. 3/16 to ¼″ |
| 8. Few blisters under primer along scribe line. (<12) | H. ¼ to ⅜″ |
| 9. Many blisters under primer along scribe line | |
| 10. Slight lift along scribe lines. | |
| 11. Coating curling up along scribe. | |
| 12. Pin point sites/pits of corrosion on organic | |
| coating surface ( 1/16″ to ⅛″ dia.). | |
| 13. One or more blisters on surface away from scribe. | |
| 14. Many blisters under primer away from scribe. | |
| 15. Starting to blister over surface. | |

B. Self-Priming Topcoat Coating Composition

A self-priming topcoat coating composition comprising a polyester resin and one or more Group I A or Group II A, and/or yttrium, and/or lanthanide compounds was prepared with the base formulation shown in Table 4 below. The self-priming topcoat coating composition was prepared by stirring an isocyanate catalyst (97GY088CAT (Deft Inc., Irvine, Calif.)), into the base formulation. The amount of isocyanate catalyst included in the coating composition was added according to the amount recommended by the supplier.

Once the base and isocyanate catalyst were mixed together, test sample 7 was prepared by spraying the self-priming topcoat coating composition onto a metal substrate and allowing the substrate to dry (cure) naturally over time for about one week. The edges and back of test sample 7 were taped and the front surface was scribed with an “X” pattern and tested according to ASTM B117 procedure. The results were scored according to the Keller Corrosion Rating Scale shown in Table 3 above. Table 5 shows the amount of corrosion-inhibiting compounds in the coating composition as well as the 2000 hour salt fog test rating score.

TABLE 4
Self-priming Topcoat Base Formulation

| Component | mass (g) |
|---|---|
| Polyester Resin Blend (binder) | |
| Desmophen 631A-75 (Mobay Corp., Pittsburg, PA) | 74.4 |
| Desmophen 670A-80 (Mobay Corp., Pittsburg, PA) | 51.8 |
| Kflex188 (King Industries, Norwalk, CT) | 180.8 |
| Dispersing Agent | |
| Hypermer 2234 (ICI, London, England) | 2 |
| Solvent | |
| N-Butyl Acetate | 43 |
| Methyl Ethyl Ketone | 66 |
| 2,4-Pentanedione | 14 |
| Additives | |
| BYK 302 (BYK Chemie, Wesel, Germany) | 1 |
| FC-4430 (3M Corp., St. Paul, MN) | 3 |
| Suspend 201-NBA (Poly-Resyn, Inc., Dundee, IL) | 3 |
| Color Pigments | 265 |
| Neutral to Acidic Extenders and/or | 296 |
| Corrosion Inhibitive Pigments | |
| Base Total: | 1000 |

TABLE 5
Self-priming Topcoat Formulations (Prior Art Example).

| | | | | 2000 |
|---|---|---|---|---|
| | | Weight Percent | **Weight Percent | Hours |
| Sample | *Deft | Corrosion- | Corrosion-Inhibiting | Salt Fog |
| Number | Primer | Inhibiting Extender | Rare Earth Element | Rating |
| 7 | 03W211 | 44% CaSO₄.2H₂O | 8% Pr₂O₃ | 3, 5 |

*Deft Primer number refers to product identification number of primer formulation, available from Deft Inc., having offices in Irvine, California.
**Weight percent inhibitor pigment based on total weight percent of fully catalyzed and sprayable topcoat.

C. Enhanced Self-Priming Topcoat Formulations.

Enhanced self-priming topcoat coating compositions comprising a polyester resin and one or more Group I A or Group II A, and/or yttrium, and/or lanthanide compounds were prepared with the base formulation shown in Table 1 above with the amount of corrosion-inhibitor, pigment, and extender shown in Table 6 below. The enhanced self-priming topcoat coating compositions shown in Table 6 below were prepared by stirring an isocyanate catalyst (97GY088CAT (Deft Inc., Irvine, Calif.)), into the base formulations. The amount of isocyanate catalyst included in the coating composition was added according to the amount recommended by the supplier.

Once the base and isocyanate catalyst were mixed together, test samples 8-15 was prepared by spraying the self-priming topcoat coating composition onto a metal substrate and allowing the substrate to dry (cure) naturally over time for about one week. The edges and backs of test samples 8-15 were taped and the front surfaces were scribed with an “X” pattern and tested according to ASTM B117 procedure. The results were scored according to the Keller Corrosion Rating Scale shown in Table 3 above. Table 6 shows the amount of corrosion-inhibiting compounds in the coating composition as well as the 2000 hour salt fog test rating score.

TABLE 6
Enhanced Self-priming Topcoat Formulations.

| | **Corrosion | | | | | | 2000 Hr |
|---|---|---|---|---|---|---|---|
| Sample | Inhibitor/ | | **Color Pigment/Weight | | ***Extender/ | | Salt Fog |
| Number | Weight Percent | | Percent | | Weight Percent | | Rating |
| 8 | Pr₂O₃ | 12.89 | Titanium Dioxide | 13.89 | Lo-Vel ™ | 25.17 | 1A |
| | CaSO₄.2H₂O | 47.74 | Iron Yellow Oxide | 0.17 | HSF | | |
| | | | Carbazole Violet | 0.01 | | | |
| | | | Phthalo Blue | 0.03 | | | |
| 9 | Pr₂O₃ | 2.14 | Titanium Dioxide | 13.26 | Lo-Vel ™ | 24.01 | 1A |
| | CaSO₄.2H₂O | 42.45 | Iron Yellow Oxide | 0.18 | HSF | | |
| | Pr₂(SO₄)₃ | 0.85 | Carbon Black | 0.10 | | | |
| | Pr₆O₁₁ | 16.98 | Phthalo Blue | 0.03 | | | |
| 10 | Pr₆O₁₁ | 23.62 | Titanium Dioxide | 12.83 | Lo-Vel ™ | 23.23 | 2A |
| | CaSO₄.2H₂O | 40.03 | Iron Yellow Oxide | 0.16 | HSF | | |
| | | | Carbazole Violet | 0.09 | | | |
| | | | Phthalo Blue | 0.03 | | | |
| 11 | Pr₂O₃ | 2.49 | Titanium Dioxide | 10.25 | Lo-Vel ™ | 17.48 | 1A |
| | CaSO₄.2H₂O | 48.97 | Iron Yellow Oxide | 0.13 | HSF | | |
| | Pr₂(SO₄)₃ | 0.99 | Carbazole Violet | 0.01 | | | |
| | Pr₆O₁₁ | 19.58 | Carbon Black | 0.07 | | | |
| | | | Phthalo Blue | 0.03 | | | |
| 12 | Pr₂O₃ | 1.54 | Titanium Dioxide | 18.85 | Lo-Vel ™ | 35.69 | 3A |
| | CaSO₄.2H₂O | 30.63 | Iron Yellow Oxide | 0.24 | HSF | | |
| | Pr₂(SO₄)₃ | 0.61 | Carbazole Violet | 0.01 | | | |
| | Pr₆O₁₁ | 12.25 | Carbon Black | 0.13 | | | |
| | | | Phthalo Blue | 0.05 | | | |
| 13 | Pr₂O₃ | 14.98 | Titanium Dioxide | 10.82 | Lo-Vel ™ | 18.47 | 1A |
| | CaSO₄.2H₂O | 55.48 | Iron Yellow Oxide | 0.14 | HSF | | |
| | | | Carbazole Violet | 0.01 | | | |
| | | | Carbon Black | 0.07 | | | |
| | | | Phthalo Blue | 0.03 | | | |
| 14 | Pr₂O₃ | 14.16 | Titanium Dioxide | 12.25 | Lo-Vel ™ | 20.89 | 1A |
| | CaSO₄.2H₂O | 52.43 | Iron Yellow Oxide | 0.15 | HSF | | |
| | | | Carbazole Violet | 0.01 | | | |
| | | | Carbon Black | 0.08 | | | |
| | | | Phthalo Blue | 0.03 | | | |
| 15 | Pr₂O₃ | 14.73 | Titanium Dioxide | 10.25 | Lo-Vel ™ | 18.58 | 3A |
| | SrSO₄ | 56.21 | Iron Yellow Oxide | 0.13 | HSF | | |
| | | | Carbazole Violet | 0.01 | | | |
| | | | Carbon Black | 0.07 | | | |
| | | | Phthalo Blue | 0.03 | | | |

**Weight percent of inhibitor and pigment is based on the total weight percent of fully catalyzed and sprayable topcoat.
***Weight percent of extender is based on the total weight percent of fully catalyzed and sprayable topcoat. Lo-Vel ™ HSF, available from PPG Industries, having offices in Pittsburgh, PA.

D. Test Results

The minimum acceptable corrosion resistance varies with the application. However, as noted above, good corrosion resistance is considered to be a reading of “2”, “4” and “A,” with excellent corrosion resistance being at least “1” and “A.”

As shown in Table 6, an enhanced self-priming topcoat coating compositions having corrosion-inhibiting extenders in conjunction with corrosion-inhibiting rare earth element compounds provide superior corrosion resistance as compared to the prior art, primer plus topcoat coating compositions and self-priming coating composition, shown in Tables 2 and 5, respectively. As shown in Table 2, incorporating corrosion inhibitors directly into a topcoat and applying over a primer, results in coating systems that do not perform as well as the enhanced self-priming coating compositions shown in Table 6. Table 5 shows comparable performance of the self-priming topcoat coating composition to the primer plus topcoat formulations shown in Table 2. As shown in Table 6, the enhanced self-priming topcoat coating compositions perform better than the prior art coating compositions shown in Tables 2 and 5.

Example 2 demonstrates that better corrosion protection can be obtained with enhanced self-priming topcoat (ESPT) coating compositions. The (ESPT) coating compositions have both excellent weathering resistance and durability, as well as the corrosion resistance necessary to provide protection to underlying substrates. Further, the (ESPT) coating compositions are non-chromium containing, alleviating the concerns associated with currently known chromium containing coating systems. Finally, the (ESPT) coating compositions provide corrosion protection as a one-coat system without the need for an inter-coat polymeric coating or primer, thus minimizing the production time and costs of producing industrial, consumer, and military parts and goods. Accordingly,

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference in their entirety.

What is claimed is:

1. A curable corrosion-inhibiting coating composition comprising:
a fluorinated binder; and
an effective amount of a corrosion-inhibiting compound selected from the group consisting of one or more of a corrosion-inhibiting extender, a corrosion-inhibiting rare earth compound, and a corrosion-inhibiting carbon pigment, and combinations thereof.

2. A coating composition according to claim 1 wherein the coating composition is capable of binding to an underlying substrate without an intermediate polymeric coating and capable of providing corrosion protection to the underlying substrate.

3. A coating composition according to claim 1 wherein the fluorinated binder is a fluorinated vinyl ether.

4. A coating composition according to claim 1 further comprising an additive.

5. A coating composition according to claim 1 further comprising one or more corrosion inhibiting co-inhibitors.

6. A coating composition according to claim 5 wherein the co-inhibitor is selected from the group consisting of amine containing compounds, sulfur containing compounds, phosphorus containing compounds, polyaniline, ionic exchange resins, amino acids, derivatives of amino acids, dextrins, cyclodextrins, and combinations thereof.

7. A coating composition according to claim 1 wherein the corrosion-inhibiting compound is present in the composition in a pigment volume concentration of about 0.1% to about 65%.

8. A corrosion-inhibiting coating composition according to claim 1 wherein the corrosion-inhibiting compound is a corrosion-inhibiting extender, present in the composition in an amount from about 45 wt % to about 75 wt % of the solid components present in the composition.

9. A coating composition according to claim 8 wherein the extender is selected from a group consisting of metal cation sulfates, metal cation phosphates, metal cation nitrates, metal cation silicates, and combinations thereof.

10. A coating composition according to claim 9 wherein the metal cation is selected from the group consisting of barium, strontium, and calcium, and combinations thereof.

11. A coating composition according to claim 9 wherein the metal cation is selected from the group consisting of yttrium, a lanthanide, and combinations thereof.

12. A corrosion-inhibiting coating composition according to claim 1 wherein the corrosion-inhibiting compound is a corrosion-inhibiting rare earth compound.

13. A coating composition according to claim 12 wherein the rare earth compound is selected from the group consisting of praseodymium oxides, praseodymium hydroxides, praseodymium solid solution mixed oxides, a mixture of praseodymium oxides, a mixture of praseodymium hydroxides, praseodymium nitrate, praseodymium sulfate, praseodymium phosphate, and combinations thereof.

14. A corrosion-inhibiting coating composition according to claim 1 wherein the corrosion-inhibiting compound is a corrosion inhibiting carbon pigment.

15. A coating composition according to claim 14 wherein the carbon pigment is a surface or pH modified carbon pigment.

16. A coating composition according to claim 1 further comprising
a polyester resin blend;
a dispersing agent; and
a color pigment,
wherein the corrosion-inhibiting compound is a combination of a corrosion-inhibiting extender and a corrosion-inhibiting rare earth compound.

17. A substrate directly coated with a cured coating composition, the coating composition comprising:
a fluorinated binder; and
an effective amount of a corrosion-inhibiting compound selected from the group consisting of a corrosion-inhibiting extender, a corrosion-inhibiting rare earth compound, a corrosion-inhibiting carbon pigment, and combinations thereof.

18. A substrate according to claim 17 wherein the substrate is formed from a material selected from the group consisting of aluminum, aluminum alloys, bare steel, galvanized steel, zinc, zinc alloys, magnesium, and magnesium alloys, and composite materials.

19. A substrate according to claim 18 wherein the material is an aluminum or an aluminum alloy.

20. A substrate according to claim 17 wherein the substrate is a polymer coated material.

21. A method for coating a substrate comprising:
pretreating the substrate with a conversion treatment;
applying a composition according to claim 1; and
curing the applied composition.

22. A method according to claim 21 wherein the conversion treatment is selected from the group consisting of cerium conversion coatings, praseodymium conversion coatings, phosphate conversion coatings, zinc-type conversion coatings, anodized coatings, anodized and sealed coatings, and chromium conversion coatings.

23. A method according to claim 22 wherein the conversion treatment is a chromium conversion treatment.

24. A method according to claim 21 wherein the substrate is formed from a material selected from the group consisting of aluminum, aluminum alloys, bare steel, galvanized steel, zinc, zinc alloys, magnesium, magnesium alloys, and composite materials.

25. A method according to claim 24 wherein the material is an aluminum or an aluminum alloy.

26. A method according to claim 21 wherein the substrate is a polymer coated material.

27. A method for coating a substrate comprising:
preparing a coating base, the coating base having a fluorinated binder and one or more corrosion-inhibiting compounds;
adding a catalyst to the coating base to form a mixture; and
applying the mixture to the substrate.

28. A method according to claim 27 wherein the catalyst is an isocyanate catalyst.

29. A method according to claim 27 wherein one or more of the corrosion-inhibiting compounds is selected from the group consisting of a corrosion-inhibiting extender, a corrosion-inhibiting rare earth compound, and a corrosion-inhibiting carbon pigment.

30. A method for coating a substrate comprising applying a corrosion-inhibiting coating composition according to claim 1 directly to a substrate without an intermediate polymeric coating between the substrate and the corrosion-inhibiting coating.
